(19) United States
(12) Patent Application Publication
(10) Pub. No.: US 2016/0149760 A1
(43) Pub. Date: May 26, 2016

(54) MULTI-STAGE CONVERGENCE AND INTENT REVOCATION IN A NETWORK ENVIRONMENT

(71) Applicant: CISCO TECHNOLOGY, INC., San Jose, CA (US)

(72) Inventors: Eric A. Voit, Bethesda, MD (US); Edward Albert Warnicke, Austin, TX (US); Ludwig Alexander Clemm, Los Gatos, CA (US); Samer Salam, Vancouver (CA)

(73) Assignee: CISCO TECHNOLOGY, INC., San Jose, CA (US)

(21) Appl. No.: 14/549,328

(22) Filed: Nov. 20, 2014

(51) Int. Cl. H04L 12/24; G06F 17/30

(52) U.S. Cl. CPC H04L 41/0813; H04L 41/0873; G06F 17/30575

(57) ABSTRACT

An example method for facilitating multi-stage convergence and intent revocation in a network environment is provided and includes sending an intent support request for an intent to a plurality of targets in a network, receiving intent pre-commits from a portion of the plurality of targets and intent pre-aborts from a remaining portion of the plurality of targets, each intent pre-commit indicative of ability to support the intent, and each intent pre-abort indicative of inability to support the intent, determining whether the intent is to be added to the domain in view of potentially impacted intents, and instructing the plurality of targets to commit to the intent if the intent is to be added to the domain.

### TECHNICAL FIELD

This disclosure relates in general to the field of communications and, more particularly, to multi-stage convergence and intent revocation in a network environment.

BACKGROUND

Data centers are increasingly used by enterprises for effective collaboration and interaction and to store data and resources. A typical data center network contains myriad network elements, including hosts, load balancers, routers, switches, etc. The network connecting the network elements provides secure user access to data center services and an infrastructure for deployment, interconnection, and aggregation of shared resource as required, including applications, hosts, appliances, and storage. Improving operational efficiency and optimizing utilization of resources in data centers are some of the challenges facing data center managers. Data center managers want a resilient infrastructure that consistently supports diverse applications and services and protects the applications and services against disruptions. A properly planned and operating data center network provides application and data integrity and optimizes application availability and performance.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 is a simplified block diagram illustrating a communication system for facilitating multi-stage convergence and intent revocation in a network environment;

FIG. 2 is a simplified block diagram illustrating example details of embodiments of the communication system;

FIG. 3 is a simplified block diagram illustrating other example details of embodiments of the communication system;

FIG. 4 is a simplified sequence diagram illustrating example operations that may be associated with embodiments of the communication system;

FIG. 5 is a simplified flow diagram illustrating other example operations that may be associated with an embodiment of the communication system;

FIG. 6 is a simplified flow diagram illustrating yet other example operations that may be associated with an embodiment of the communication system; and

FIG. 7 is a simplified diagram illustrating yet other example operations that may be associated with an embodiment of the communication system.

### DETAILED DESCRIPTION OF EXAMPLE EMBODIMENTS

### Overview

An example method for facilitating multi-stage convergence and intent revocation in a network environment is provided and includes sending an intent support request for an intent to a plurality of targets in a network, receiving intent pre-commits from a portion of the plurality of targets and intent pre-aborts from a remaining portion of the plurality of targets, each intent pre-commit indicative of ability to support the intent, and each intent pre-abort indicative of inability to support the intent, determining whether the intent is to be added to the domain in view of potentially impacted intents, and instructing the plurality of targets to commit to the intent if the intent is to be added to the domain.

As used herein, the term “intent” comprises an expression of goals and constraints that may be effectuated by a network element in a network by applying suitable configurations (e.g., rule in an access control list, port parameters, etc.). Intent may be regarded as metadata; it does not describe what has happened (e.g., data) or what is going to happen (e.g., plan or projections); instead, it describes what the intent submitter would like to happen. As used herein, the term “target” is meant to encompass any network element, including computers, network appliances, servers, routers, switches, gateways, bridges, load balancers, firewalls, processors, modules, or any other suitable device, component, element, or object operable to exchange information in a network environment. Moreover, the network elements may include any suitable hardware, software, components, modules, interfaces, or objects that facilitate the operations thereof. This may be inclusive of appropriate algorithms and communication protocols that allow for the effective exchange of data.

### Example Embodiments

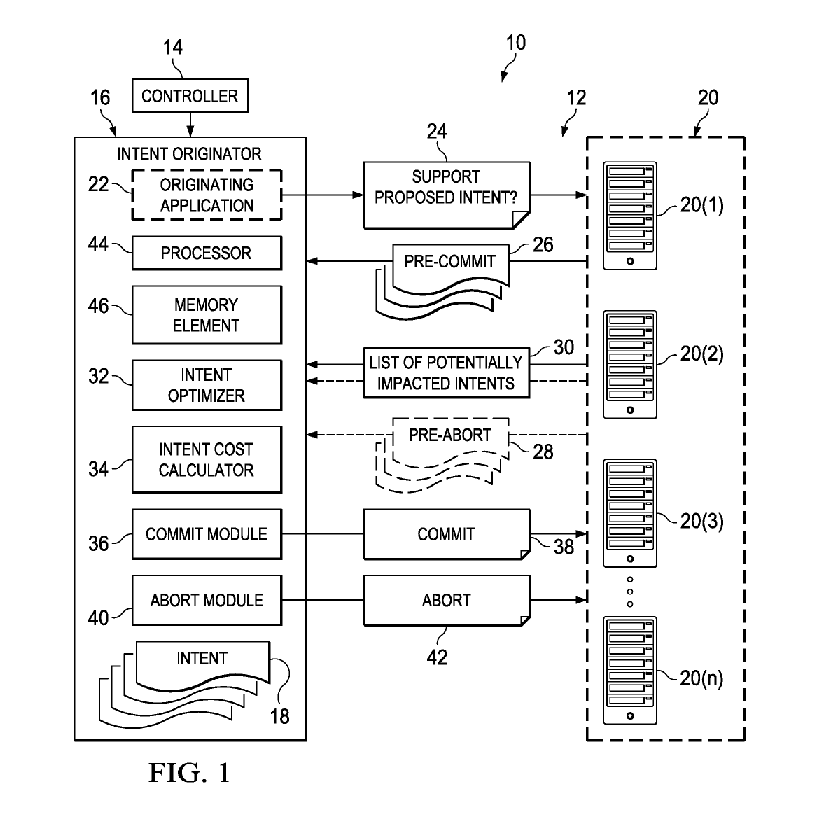

Turning to FIG. 1, FIG. 1 is a simplified block diagram illustrating a communication system 10 for facilitating multi-stage convergence and intent revocation in a network environment in accordance with one example embodiment. An example embodiment of communication system 10 includes a network 12 comprising a controller 14 controlling a policy domain in network 12. Network 12 may include other controllers that control corresponding other policy domains in network 12. In a general sense, a policy domain includes a network segment in which certain policies may be asserted over substantially all network elements in the network segment. Separate policy domains may have separate policies asserted in the respective network elements. Each policy domain can span any suitable geographic area, from a few network elements within a small local area, to large global deployments spanning international boundaries.

Controller 14 may interact with an intent originator 16. In some embodiments, network originator 16 may execute in, or with, controller 14 in the same network element. In other embodiments, controller 14 and intent originator 16 may execute concurrently in different but connected network elements. In various embodiments, controller 14 may attempt to apply one (or more) policy(ies) through a corresponding intent 18 on various targets 20 (e.g., 20(1)-20(N)) in network 12 with the help of intent originator 16. Intent originator 16 may evaluate intent pre-commits across targets 20. When a threshold mass of commitment is achieved, the intent gets approved domain wide. In targets 20, an intent optimization operation may resolve a continuous stream of potentially conflicting directives when multiple controllers (e.g., 14) serving overlapping sets of network elements conflict in their respective intents (e.g., policy goal), such as intent 18.

In a general sense, policy-based management, as in policy domains, allows configuring and reconfiguring differentiated services networks to achieve desired Quality of Service (QoS) goals. Relevant configuration involves implementing network provisioning decisions, performing admission control, and adapting bandwidth allocation dynamically according to emerging traffic demands. The policy-based approach can facilitate flexibility and adaptability, for example, to change the policies without changing the implementation in a particular network element. However, as with any other complex system, conflicts and inconsistencies may arise in the policy specification.

For example, networks are increasingly being managed as a system through a single point of administration and control, as opposed to users dealing with the network one device at a time. However, networks continue to consist of multiple interconnected devices each with their own configuration, which can lead to policy conflicts in implementation. Such may be the case even with large-scale deployment of controller-based software defined networking (SDN) architectures, because some functionality may be provided locally (e.g. at the edge of a network), without referring back to a centralized controller each time. One general problem in applying intent across such networks concerns consistent application of intent.

For example, multiple network controllers may attempt to apply different policies on overlapping sets of targets 20. As targets 20(1)-20(N) try to arbitrate between the sets of commands they are given from disparate controllers, unexpected configuration conflicts may arise, which may have to be resolved before the policy or associated configuration changes can be applied. Such resolutions may involve rollback of changes even in the midst of committing a high level policy across a large network domain. Embodiments of communication system 10 can maintain network domain and device consistency in the presence of a stream of declarative assertions from multiple sources, including apparently authoritative sources at different levels of abstraction. Embodiments of communication system 10 can facilitate rapid intent conflict identification and resolution for consistency across network domains and devices.

In a general sense, any suitable routing protocol can facilitate convergence because each protocol assumes a state machine within a specific network element that knows how to converge consistent network state over multiple other network elements. However, such routing protocols do not involve different levels of abstraction for various types of network elements that can be pulled into the convergence process. For example, partitioned database technologies applicable to convergence includes intent frameworks and optimization engines that store and maintain intent execution plan and dependency graph (e.g., databases built on BASE and Eventual Consistency deployed for large scale shopping cart systems have been measured at 81% improved latency response times). However, such partitioned database technologies have not been applied to network elements in a network context, much less in a multi-controller network environment.

In distributed and replicated database systems, when a transaction spans several sites, the database servers at all sites have to reach a common decision regarding whether the transaction should be committed. A mixed decision can result in an inconsistent database, whereas a unanimous decision can guarantee atomicity of the transaction. A two-phase commit protocol that can guarantee atomicity is typically a blocking protocol, wherein, if the coordinator fails, all sites remain blocked indefinitely. In a network context, such a two-phase commit protocol may imply that that the configuration encompassed by a specific intent take effect across all network elements where it is to be applied, or not at all. However, a single failure to commit a configuration or apply an action at a single network element can negate the entire transaction and prevent it from taking effect at any of the network elements. Delays encountered at one system (for example, due to need for multiple retries for internal reasons, intermittent communication failures, etc.) affect the entire network. In effect, the ‘herd’ of networking network elements only moves as slow as its slowest member.

To reduce blocking, a three phase commit algorithm, such as quorum based three phase commit (3PC) and Enhanced Three Phase Commit (E3PC), may be used to apply configuration settings on network elements, for example, in atomicity, consistency, isolation and durability (ACID) transactions in distributed database topologies. In the 3PC algorithm, a quorum (e.g., majority) based recovery procedure is followed that allows a quorum to resolve the transaction. However, if the failures cascade, the quorum in the system is lost while remaining connected and blocked. In contrast, E3PC maintains consistency in the face of site failures and network partitions: at any time during the protocol execution, if a group of sites are connected and the group contains a quorum and no subsequent failures occur for sufficiently long, all the members can eventually reach a decision. However, such algorithms are not optimal for business processes in which response time or availability is more critical than immediate 100% accuracy at commit time.

To ensure eventual network consistency without ACID, network elements should converge with one another about which written object states will take precedence when a conflicting set of values is discovered. In various embodiments, the conflict resolution uses Active Anti-Entropy (AAE), which can facilitate solving availability versus partition challenges. As an example of AAE, consider Amazon's shopping cart system in a situation in which a specific product type has been oversold due to distributed compute optimizations. In such a situation, to determine which customer gets the last item of the product type can be a non-trivial problem. Using a human for each such decision can be highly inefficient. Instead, AAE can be used to resolve the problem. In a general sense, AAE, which includes a continuous automatic background process with no human intervention that compares and repairs any divergent, missing, or corrupted replicas, can ensure the integrity of all data stored in the database.

Mechanisms for delivering AAE can take a variety of forms, such as Last Write Wins and Conflict free Replicated Data Types (CRDT) (which can include convergent replicated data types (CvRDT) and commutative replicated data types (CmRDT)), and semantic resolution. In Last Writer Wins, a winner (between conflicted data) is chosen based on the timestamp embedded in each write operation. However care is needed to address clock drift (e.g., with precise synchronization of timers between conflicted nodes). In CRDT (e.g., routing protocols), the data converges eventually without requiring application or human intervention. Semantic resolution requires user or application involvement and can be expensive. However, none of such mechanisms intersect AAE with a mechanism for prioritizing various types of intents so that conflict resolution in intents can be resolved programmatically.

Embodiments of communication system 10 can facilitate operations in real time that can balance needs of asserted and potentially conflicting intents. The operations may be structured to provide the same object end values by any randomized delivery of intents through automatic convergence. (In such embodiments, any transaction may be considered as CvRDT.) In some embodiments, an extra cost for changing established configurations may be added, for example, as long as each established configuration is acknowledged in ACID form across all domains before full commit, and CRDT is consistently applied to the remainder of the transactions.

In various embodiments, ancestry (e.g., association, binding, hierarchy, etc.) of a configlet to the original intent(s) 18 that drove that configlet's creation may be resolved (e.g., determined, identified, calculated, etc.) appropriately (e.g., using any known method). As used herein, the term “configlet” refers to an object based application programming interface (API), for example, which can be implemented using one or more lines of commands on a command line interface (CLI) and is an implementable form of one or more intents (e.g., intent 18). In a general sense, the configlet is a configuration template that is transformed to a CLI configuration string before being applied to a network element (e.g., 20). In some embodiments, the dynamic elements (e.g., strings) in configlets are defined using variables, which act as inputs to a process of transformation to construct the CLI configuration string. In other embodiments, the strings in configlets can be created using XML objects that accomplish the same objective as the CLI string. The variables can comprise any suitable parameter, such as interface name, device name, description text, or any similar dynamic values. The values of the variables can be based on the intent (e.g., 18) that guides the configlet. In various embodiments, a registry may be created that defines the association of each configlet with one or more guiding intents. With such binding (e.g., association) of configlet to intent, it can be possible to produce a union (e.g., convergence) of supported intents for a particular network element, such as one or more of targets 20.

In various embodiments, a business value of any particular intent 18 may be established automatically based on a number of criteria. For example, a global security mandate could be given the value of “cannot be violated”, a security guideline given a value of “100”, and a High Availability requirement given a value of “800”. Business logic can process the full set of intents for a domain optimized answer of what intents should be installed in the specific policy domain.

In an example, assume that an originating application 22 at intent originator 16 sends an intent support request 24 for intent 18 to plurality of targets 20 in network 12. Intent originator 16 may receive intent pre-commits 26 from a portion of plurality of targets 20 (e.g., 20(1), 20(2)) and intent pre-aborts 28 from a remaining portion of plurality of targets 20 (e.g., 20(3)-20(N)), each intent pre-commit 26 indicative of ability to support intent 18, and each intent pre-abort 28 indicative of inability to support intent 18, each intent pre-abort 28 also including a list of potentially impacted intents 30 that would be revoked should intent 18 be supported at the respective responder targets 20. An intent optimizer 32 may determine whether intent 18 is to be added to the domain in view of list of potentially impacted intents 30. For example, a cost calculator 34 may compute the cost associated with applying intent 18 on targets 20. A commit module 36 may instruct plurality of targets 20, through a commit 38 (e.g., instruction to commit to intent 18), to commit to intent 18 if it is determined that intent 18 is to be added to the domain. Alternatively, an abort module 40 may notifying originating application 22 that intent 18 cannot be serviced if intent 18 is too costly to be added to the domain and an abort 42 (e.g., instruction to abort intent 18) may be sent to targets 20 to abort implementation of intent 18.

In specific embodiments, intent 18 is added to the domain if a threshold number of intent pre-commits 26 are received. The threshold may be set according to various appropriate criteria suitable to the specific networking context. For example, the threshold may be set at 80%: in other words, if 80% of targets 20 respond with pre-commits 26, intent 18 may be applied across all targets 20 in the domain. In some embodiments, a cost may be associated with revoking each intent in list of potentially impacted intents 30, and another cost may be associated with breaking an existing intent at any target (e.g., 20(N)).

Turning to the infrastructure of communication system 10, the network topology can include any number of servers, hardware accelerators, virtual machines, switches (including distributed virtual switches), routers, and other nodes inter-connected to form a large and complex network. A node may be any electronic device, client, server, peer, service, application, or other object capable of sending, receiving, or forwarding information over communications channels in a network. Elements of FIG. 1 may be coupled to one another through one or more interfaces employing any suitable connection (wired or wireless), which provides a viable pathway for electronic communications. Additionally, any one or more of these elements may be combined or removed from the architecture based on particular configuration needs.

Communication system 10 may include a configuration capable of TCP/IP communications for the electronic transmission or reception of data packets in a network. Communication system 10 may also operate in conjunction with a User Datagram Protocol/Internet Protocol (UDP/IP) or any other suitable protocol, where appropriate and based on particular needs. In addition, gateways, routers, switches, and any other suitable nodes (physical or virtual) may be used to facilitate electronic communication between various nodes in the network.

Note that the numerical and letter designations assigned to the elements of FIG. 1 do not connote any type of hierarchy; the designations are arbitrary and have been used for purposes of teaching only. Such designations should not be construed in any way to limit their capabilities, functionalities, or applications in the potential environments that may benefit from the features of communication system 10. It should be understood that communication system 10 shown in FIG. 1 is simplified for ease of illustration.

The example network environment may be configured over a physical infrastructure that may include one or more networks and, further, may be configured in any form including, but not limited to, local area networks (LANs), wireless local area networks (WLANs), VLANs, metropolitan area networks (MANs), VPNs, Intranet, Extranet, any other appropriate architecture or system, or any combination thereof that facilitates communications in a network.

In some embodiments, a communication link may represent any electronic link supporting a LAN environment such as, for example, cable, Ethernet, wireless technologies (e.g., IEEE 802.11x), ATM, fiber optics, etc. or any suitable combination thereof. In other embodiments, communication links may represent a remote connection through any appropriate medium (e.g., digital subscriber lines (DSL), telephone lines, T1 lines, T3 lines, wireless, satellite, fiber optics, cable, Ethernet, etc. or any combination thereof) and/or through any additional networks such as a wide area networks (e.g., the Internet).

In various embodiments, controller 14 may comprise one or more applications executing in suitable network elements in network 12. Controller 14 can include appropriate rules engines, data stores, semantic reasoners, and other components to enable operations as described herein. Intent originator 16 may comprise a suitable application executing inside a server or other network element in network 12 according to some embodiments. According to other embodiments, intent originator 16 may comprise a stand-alone network appliance that may be plugged into network 12 and communicate with targets 20 and controller 14 suitably. For example, intent originator 16 may perform its various operations using a hardware processor 44 and a memory element 46.

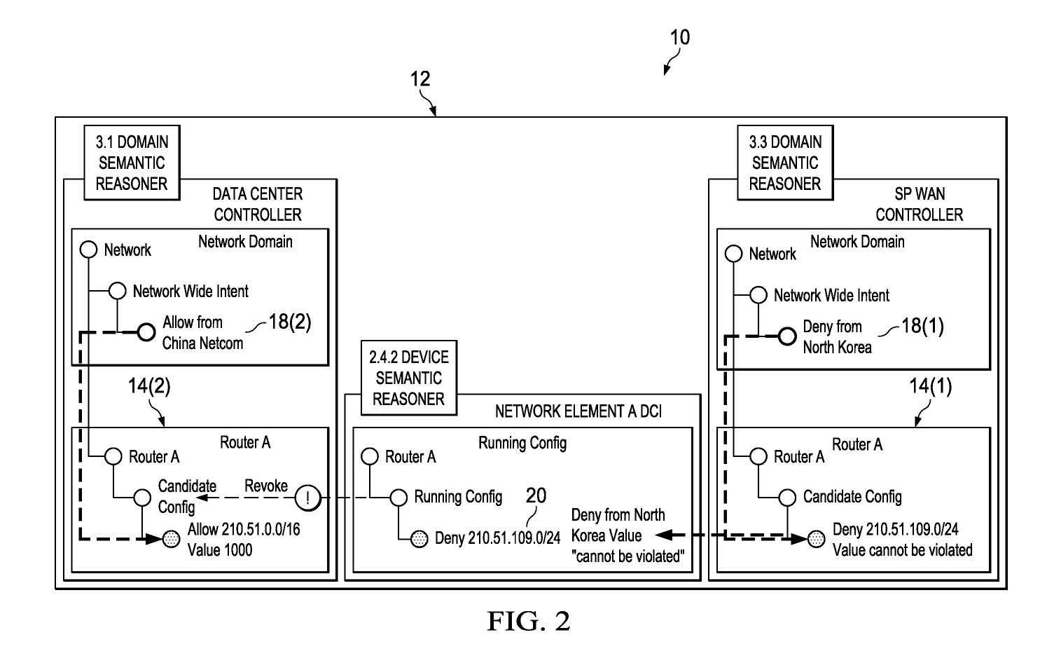

Turning to FIG. 2, FIG. 2 is a simplified block diagram illustrating example details of an embodiment of communication system 10. FIG. 2 illustrates network 12 comprising two policy domains, a service provider (SP) wide area network (WAN) policy domain controlled by a SP WAN controller 14(1) and a data center policy domain controlled by data center controller 14(2). Each policy domain may comprise a plurality of network elements, such as example target 20, on which domain specific policies may be applied.

Assume, merely for example purposes that SP WAN controller 14(1) generates a policy that results in a network wide intent 18(1) to deny traffic from North Korea at any network element located in South Korea. By way of example only, the policy can result from a South Korea law mandating that no traffic from North Korea is allowed on its soil. Assume also that example target 20 is located in South Korea. Intent 18(1) may be asserted at target 20, for example, by sending an intent support request; intent 18(1) may be implemented as a configlet with CLI commands to monitor traffic and deny any traffic to and from IP addresses 210.51.109.0/24, which correspond to hosts located in North Korea.

Assume, merely for example purposes that data center controller 14(2) generates another policy that results in a network wide intent 18(2) to allow traffic from China Netcom, which provides a subnet that can include North Korean traffic. Intent 18(2) may be asserted at target 20, for example, by sending an intent support request; intent 18(2) may be implemented as a configlet with CLI commands to monitor traffic and allow any traffic to and from a larger IP subnet such as 210.51.0.0/16. A conflict thus arises at target 20 between intents 18(1) (e.g., to deny traffic to and from 210.51.109.0/24) and 18(2) (e.g., to allow traffic to and from 210.51.0.0/16). According to various embodiments, target 20 may pre-commit to the first asserted intent (e.g., intent 18(1)) and run optimization operations to determine if the later asserted intent 18(2) is to be respected over the prior asserted intent 18(1). If not, a pre-abort may be sent by target 20 to data center controller 14(2).

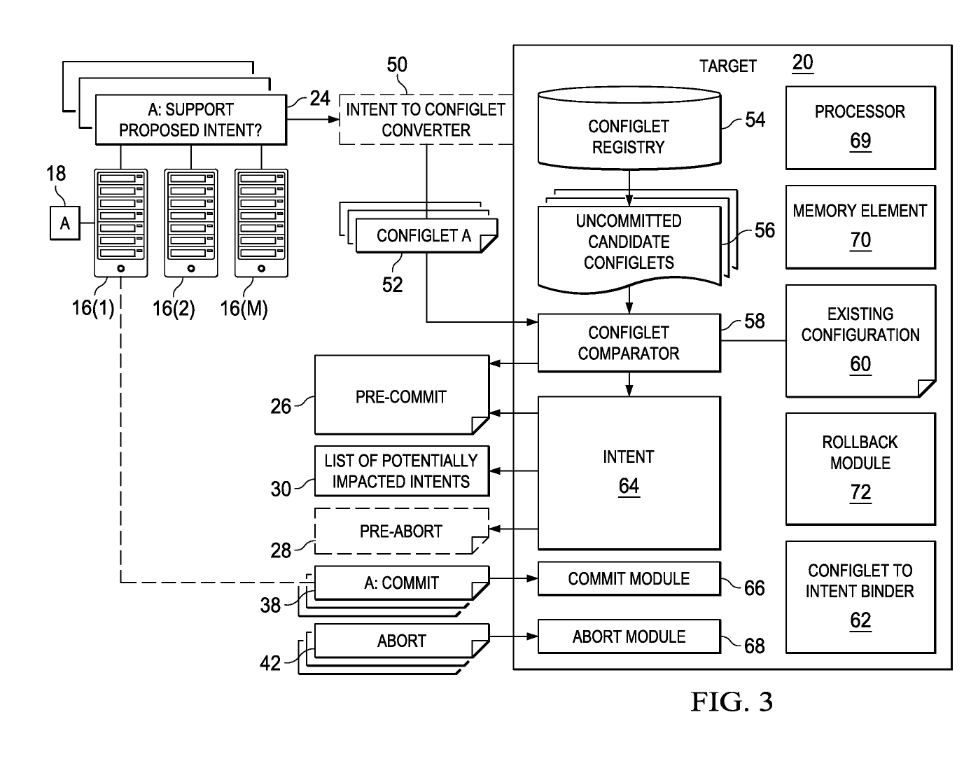

Turning to FIG. 3, FIG. 3 is a simplified block diagram illustrating example details of an embodiment of communication system 10. In some embodiments, example target 20 may receive intent support requests 24 from a plurality of intent originators 16(1)-16(M). An intent to configlet converter 59 may convert the received intents to corresponding configlets 52. Assume, merely for example purposes, that a specific intent support request A 24 from a particular intent generator 16(1) corresponds to a particular intent A 18, and is converted to corresponding configlet A 52.

A configlet registry 54 in target 20 may store substantially all such received configlets 52. Uncommitted candidate configlets 56 (e.g., received within a predetermined prior time period (e.g., previous 1 hour) and which have not been implemented) may be compared with configlets 52 by a configlet comparator 58. In some embodiments, an existing configuration 60 of target 20 may also be compared with configlets 52. The comparison may facilitate determining any conflict with any of configlets 52. If no conflict exists, target 20 sends intent pre-commit 26 to corresponding intent originators (e.g., 16(1)).

On the other hand, if a conflict exists, target 20 calculates list of potentially impacted intents 30 that intersect with the respective intent (e.g., intent A) and would be revoked should respective intent (e.g., intent A) be mandated for support. In some embodiments, a configlet to intent binder 62 may facilitate determining list of potentially impacted intents 30 based on configlets stored in configlet registry 54. In some embodiments, an intent optimizer 64 at target 20 may determine if a change is needed to existing configuration 60 in view of the conflict. If change is not needed, target 20 sends intent pre-commit 26 and list of potentially impacted intents 30 to appropriate intent originators (e.g., 16(1)). On the other hand, if it is determined that change is needed to existing configuration 60 in view of the conflict, target 20 sends intent pre-abort 28 and list of potentially impacted intents 30 to appropriate intent originators (e.g., 16(1)). In many embodiments, target 20 may also inform intent originators (e.g., 16(1)) whether the conflict is with existing configuration 60 or with uncommitted candidate configlets 56.

In some embodiments, target 20 may receive a plurality of commits 38 to commit various intents. For example, commit A 38 may be received from originator 16(1)), with an instruction to commit intent A 18. If conflict exists with intent A 18 (e.g., as determined previously), target 20 revokes previously committed intents and rollbacks revoked configlets corresponding to the revoked intents. For example, a commit module 66 may facilitate committing intent A 18 according to commit A 38. Committing intents 18 may involve applying appropriate values to variables in corresponding configlets and adding the resulting configuration settings to existing configuration 60. Note that in various embodiments, a plurality of intent originators 16(1)-16(M) may send intent support requests to plurality of targets 20(1)-20(N). Note that in many embodiments, target 20 may include a processor 69 and a memory element 70 for facilitating the operations described herein. Furthermore, a rollback module 72 may process any received aborts 42, which can include instructions to abort a specific intent (e.g., intent A 18). Aborting or committing to a specific intent may also involve invoking rollback module 72 to rollback any revoked intents (e.g., from list of potentially impacted intents 30). Rollback can involve revoking the intent, and deleting the relevant configuration settings from existing configuration 60.

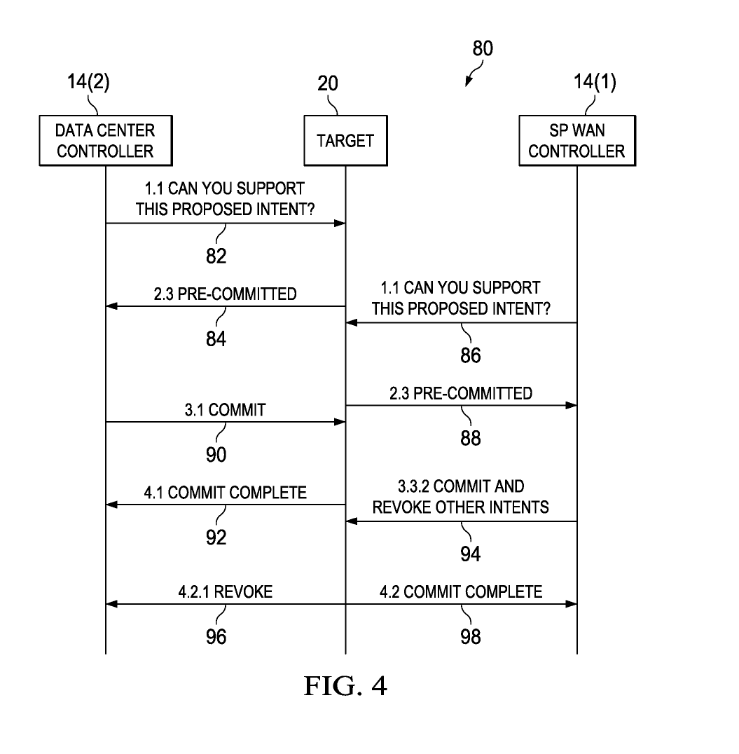

Turning to FIG. 4, FIG. 4 is a simplified sequence diagram illustrating example operations 80 that may be associated with embodiments of communication system 10. Assume, merely for example purposes, that data center controller 14(2) and SP WAN controller 14(1) send conflicting intent support requests to target 20. At 82, data center controller 14(2) may send a first intent support request to target 20. For example, the intent support request may specify that all traffic from China Netcom be allowed by target 20. At 84, target 20 may send a pre-commit in response. At 86, SP WAN controller 14(1) may send another intent support request to target 20. For example, the intent support request may specify that all traffic from North Korea (which can include China Netcom traffic) be denied by target 20. At 88, target 20 may send a pre-commit to SP WAN controller 14(1).

In various embodiments, the pre-commit from target 20 to SP WAN Controller 14(1) may specify that the previously received intent at target 20 that China Netcom traffic be allowed will be revoked should the intent from SP WAN Controller 14(1) be mandated for support and be allowed. A decision may be made at SP WAN controller 14(1) whether to apply the deny North Korea traffic or the allow China Netcom traffic. The decision may be based on various optimization algorithms, which enable balancing of legal, security, revenue, and cost considerations (among others).

Meanwhile at 90, data center controller 14(2) may send a commit instruction to target 20. At 92, target 20 may apply the intent to allow China Netcom traffic and respond with a commit complete message. At 94, SP WAN Controller 14(1) may decide that denying North Korea traffic has precedence over allowing China Netcom traffic and send an instruction to target 20 to commit to its intent and revoke other intents. At 96, target 20 may send a revoke to data center controller 14(2), revoking the commitment to allow China Netcom traffic. At 98, target 20 may send a commit complete response to SP WAN controller 14(1) indicating that the intent to deny North Korea traffic has been committed.

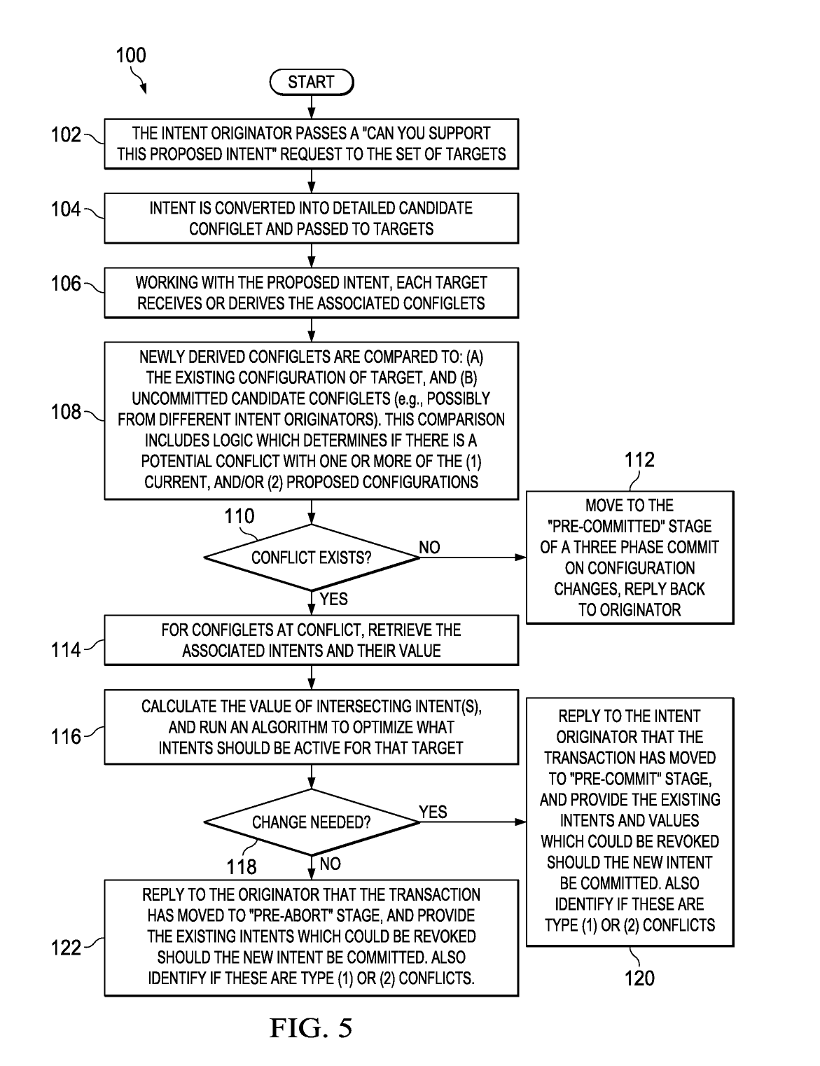

Turning to FIG. 5, FIG. 5 is a simplified flow diagram illustrating example operations 100 that may be associated with embodiments of communication system 10. At 102, intent originator passes a “can you support his proposed intent (intent 18)?” intent support request 24 to a set of targets 20. At 104, intent 18 is converted into a detailed candidate configlet 52 and passed to targets 20. Alternatively, at 106, each of targets 20 receives or derives associated configlets 52. Note that for ease of discussion, the following operations are described with reference to a single target 20; however, the operations are performed at each of targets 20 that receive intent support request 24.

At 108, newly derived configlets 52 are compared to (a) existing configuration 60 and (b) uncommitted candidate configlets 56 (e.g., possibly from different intent originators). The comparison includes logic, which determines if there is a potential conflict with one or more of the (1) current and/or (2) proposed configurations. At 110, a determination is made whether a conflict exists. If it does not, at 112, corresponding target 20 moves to a pre-committed stage of a three phase commit on configuration changes, and replies back to intent originator 16 with pre-commit 26. Note that a three phase commit includes a wait phase (during which target 20 awaits further instructions or decisions), a pre-commit phase (during which target 20 sends pre-commit 26 to intent originator) and a commit phase (during which proposed intent 18 is implemented as configuration changes at target 20).

Turning back to 110, if a conflict exists, at 114, for configlets at conflict, corresponding intents and their values are retrieved. At 116, a value of intersecting intents is calculated and an optimization algorithm executed to determine intents that should be active for target 20. At 118, a determination may be made whether any change is needed to existing configuration 60. If changes are needed, at 120, target 20 may reply back to intent originator with pre-commit 26, and provide the existing intents and values to be revoked should the new intent (e.g., 18) be committed. Also, the type of conflict (e.g., whether with existing configuration 20, or uncommitted candidate configlets 56) may be identified in the message to intent originator 16. If changes are not needed, at 122, target 20 may reply back to intent originator with pre-abort 28, and provide the existing intents and values to be revoked should the new intent (e.g., 18) be committed. Also, the type of conflict (e.g., whether with existing configuration 20, or uncommitted candidate configlets 56) may be identified in the message to intent originator 16.

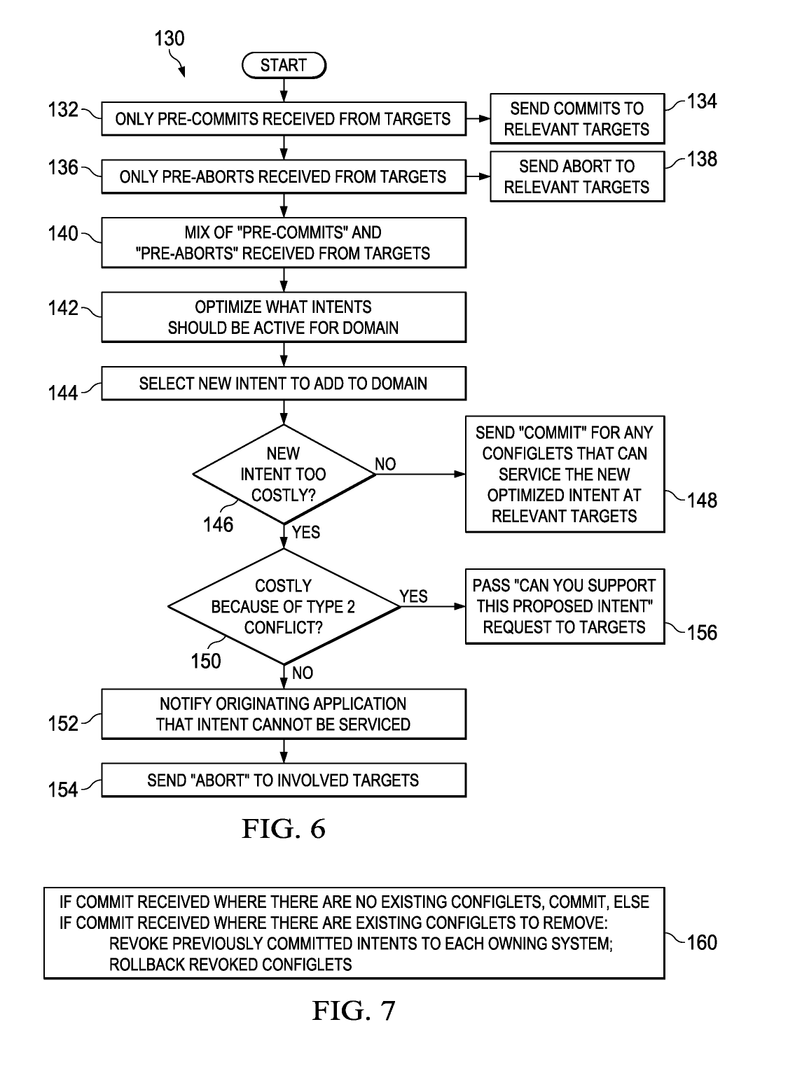

Turning to FIG. 6, FIG. 6 is a simplified flow diagram illustrating example operations 130 that may be associated with embodiments of communication system 10. At 132, intent originator 16 may receive only pre-commits 26 from targets in its domain. At 134, intent originator 16 may send commits 38 to relevant targets 20 (e.g., in domain of corresponding controller 14). At 136, intent originator 16 may only pre-aborts 28 from targets in its domain. At 138, intent originator 16 may send aborts 40 to relevant targets 20 (e.g., in domain of corresponding controller 14). At 140, intent originator 16 may receive a mix of pre-commits 26 and pre-aborts 28 from targets 20.

At 142, intent originator 16 may execute appropriate optimization algorithms to determine what intents should be active for its domain. In some embodiments, the optimization algorithm may be executed using list of potentially impacted intents 30 provided by targets 20. At 144, intent originator 16 may select one of the intents as a new intent to be added to the domain. At 146, a determination may be made whether the selected new intent is too costly (e.g., costlier than a predetermined threshold). At 148, if the new intent is not costly, intent originator 16 may send commits 38 for any configlets that can service the new optimized intent at relevant targets 20.

If the new intent is too costly, at 150, a determination may be made whether the cost is due to a conflict with proposed intents (e.g., as reflected in uncommitted candidate configlets 56) rather than with existing configuration 60. The conflict with proposed intents is referred to herein as a “type 2” conflict. If not (e.g., conflict is with existing configuration 60), at 152, originating application 22 may be notified that the intent cannot be serviced, and aborts 40 may be sent to involved targets 20. However, if the conflict is with the proposed intents, at 156, intent originator 16 may pass intent support request 24 for the new intent to targets 20 to start yet another round of operations.

Turning to FIG. 7, FIG. 7 is a simplified diagram illustrating example algorithm 160 that may be associated with targets 20 according to embodiments of communication system 10. If target 20 receives commits 38 where there are no existing configlets, commit 38 may be accepted and corresponding configlet implemented. On the other hand, if target 20 receives commits 38 where there are existing configlets to remove (e.g., revoke, delete, etc.), target 20 may revoke previously committed intents to each owning system (e.g., corresponding intent originators) and rollback revoked configlets. In other words, configuration changes implemented according to the revoked configlets may be deleted.

Note that in this Specification, references to various features (e.g., elements, structures, modules, components, steps, operations, characteristics, etc.) included in “one embodiment”, “example embodiment”, “an embodiment”, “another embodiment”, “some embodiments”, “various embodiments”, “other embodiments”, “alternative embodiment”, and the like are intended to mean that any such features are included in one or more embodiments of the present disclosure, but may or may not necessarily be combined in the same embodiments. Note also that an ‘application’ as used herein this Specification, can be inclusive of an executable file comprising instructions that can be understood and processed on a computer, and may further include library modules loaded during execution, object files, system files, hardware logic, software logic, or any other executable modules. Furthermore, the words “optimize,” “optimization,” and related terms are terms of art that refer to improvements in speed and/or efficiency of a specified outcome and do not purport to indicate that a process for achieving the specified outcome has achieved, or is capable of achieving, an “optimal” or perfectly speedy/perfectly efficient state.

In example implementations, at least some portions of the activities outlined herein may be implemented in software in, for example, targets 20, controllers 14 and/or intent originators 16. In some embodiments, one or more of these features may be implemented in hardware, provided external to these elements, or consolidated in any appropriate manner to achieve the intended functionality. The various network elements (e.g., targets 20, controllers 14 and/or intent originators 16) may include software (or reciprocating software) that can coordinate in order to achieve the operations as outlined herein. In still other embodiments, these elements may include any suitable algorithms, hardware, software, components, modules, interfaces, or objects that facilitate the operations thereof.

Furthermore, targets 20, controllers 14 and/or intent originators 16 described and shown herein (and/or their associated structures) may also include suitable interfaces for receiving, transmitting, and/or otherwise communicating data or information in a network environment. Additionally, some of the processors and memory elements associated with the various nodes may be removed, or otherwise consolidated such that a single processor and a single memory element are responsible for certain activities. In a general sense, the arrangements depicted in the FIGURES may be more logical in their representations, whereas a physical architecture may include various permutations, combinations, and/or hybrids of these elements. It is imperative to note that countless possible design configurations can be used to achieve the operational objectives outlined here. Accordingly, the associated infrastructure has a myriad of substitute arrangements, design choices, device possibilities, hardware configurations, software implementations, equipment options, etc.

In some of example embodiments, one or more memory elements (e.g., memory elements 46, 70) can store data used for the operations described herein. This includes the memory element being able to store instructions (e.g., software, logic, code, etc.) in non-transitory media, such that the instructions are executed to carry out the activities described in this Specification. A processor can execute any type of instructions associated with the data to achieve the operations detailed herein in this Specification. In one example, processors (e.g., processors 44, 69) could transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable hardware processor, programmable digital logic (e.g., a field programmable gate array (FPGA), an erasable programmable read only memory (EPROM), an electrically erasable programmable read only memory (EEPROM)), an ASIC that includes digital logic, software, code, electronic instructions, flash memory, optical disks, CD-ROMs, DVD ROMs, magnetic or optical cards, other types of machine-readable mediums suitable for storing electronic instructions, or any suitable combination thereof.

These devices may further keep information in any suitable type of non-transitory storage medium (e.g., random access memory (RAM), read only memory (ROM), field programmable gate array (FPGA), erasable programmable read only memory (EPROM), electrically erasable programmable ROM (EEPROM), etc.), software, hardware, or in any other suitable component, device, element, or object where appropriate and based on particular needs. The information being tracked, sent, received, or stored in communication system 10 could be provided in any database, register, table, cache, queue, control list, or storage structure, based on particular needs and implementations, all of which could be referenced in any suitable timeframe. Any of the memory items discussed herein should be construed as being encompassed within the broad term ‘memory element.’ Similarly, any of the potential processing elements, modules, and machines described in this Specification should be construed as being encompassed within the broad term ‘processor.’

It is also important to note that the operations and steps described with reference to the preceding FIGURES illustrate only some of the possible scenarios that may be executed by, or within, the system. Some of these operations may be deleted or removed where appropriate, or these steps may be modified or changed considerably without departing from the scope of the discussed concepts. In addition, the timing of these operations may be altered considerably and still achieve the results taught in this disclosure. The preceding operational flows have been offered for purposes of example and discussion. Substantial flexibility is provided by the system in that any suitable arrangements, chronologies, configurations, and timing mechanisms may be provided without departing from the teachings of the discussed concepts.

Although the present disclosure has been described in detail with reference to particular arrangements and configurations, these example configurations and arrangements may be changed significantly without departing from the scope of the present disclosure. For example, although the present disclosure has been described with reference to particular communication exchanges involving certain network access and protocols, communication system 10 may be applicable to other exchanges or routing protocols. Moreover, although communication system 10 has been illustrated with reference to particular elements and operations that facilitate the communication process, these elements, and operations may be replaced by any suitable architecture or process that achieves the intended functionality of communication system 10.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

What is claimed is:

1. A method executed at an intent originator in a network environment, comprising:
sending an intent support request for an intent to a plurality of targets in the network;
receiving intent pre-commits from a portion of the plurality of targets and intent pre-aborts from a remaining portion of the plurality of targets, each intent pre-commit indicative of ability to support the intent, and each intent pre-abort indicative of inability to support the intent;
determining whether the intent is to be added to the domain in view of potentially impacted intents; and
instructing the plurality of targets to commit to the intent if the intent is to be added to the domain.

2. The method of claim 1, wherein the intent is added to the domain if a threshold number of intent pre-commits are received.

3. The method of claim 1, wherein a cost is associated with revoking each intent, wherein another cost is associated with breaking an existing intent at any target.

4. The method of claim 1, further comprising converting the intent support request to a configlet.

5. The method of claim 4, wherein each target compares the configlet with its existing configuration and uncommitted candidate configlets to determine any conflict with the configlet.

6. The method of claim 5, wherein if no conflict exists, the target sends an intent pre-commit to the intent originator.

7. The method of claim 5, wherein if a conflict exists, the target calculates a list of potentially impacted intents that intersect with the intent and would be revoked should the intent be mandated for support.

8. The method of claim 7, wherein the target determines if a change is needed to the existing configuration in view of the conflict, wherein if the change is not needed, the target sends an intent pre-commit.

9. The method of claim 8, wherein if the change is not needed, the target further sends the list of potentially impacted intents to the intent originator.

10. The method of claim 7, wherein the target determines if a change is needed to the existing configuration in view of the conflict, wherein if the change is needed, the target sends an intent pre-abort and the list of potentially impacted intents to the intent originator.

11. The method of claim 7, wherein the target informs the intent originator if the conflict is with the existing configuration or with the uncommitted candidate configlets.

12. The method of claim 1, wherein each target receives the instruction to commit the intent, wherein the target revokes previously committed intents if a conflict exists with the intent, wherein the target rollbacks revoked configlets corresponding to the revoked intents.

13. The method of claim 1, wherein a plurality of intent originators of different network elements in the network send intent support requests to the plurality of targets.

14. The method of claim 1, further comprising notifying an originating application that the intent cannot be serviced if the intent is not to be added to the domain.

15. Non-transitory tangible media encoding logic that includes instructions for execution, which when executed by a processor of an intent originator, is operable to perform operations comprising:
sending an intent support request for an intent to a plurality of targets in a network;
receiving intent pre-commits from a portion of the plurality of targets and intent pre-aborts from a remaining portion of the plurality of targets, each intent pre-commit indicative of ability to support the intent, and each intent pre-abort indicative of inability to support the intent;
determining whether the intent is to be added to the domain in view of potentially impacted intents; and
instructing the plurality of targets to commit to the intent if the intent is to be added to the domain.

16. The media of claim 15, wherein the operations further comprise converting the intent support request to a configlet.

17. The media of claim 16, wherein each target compares the configlet with its existing configuration and uncommitted candidate configlets to determine any conflict with the configlet.

18. The media of claim 17, wherein if a conflict exists, the target calculates a list of potentially impacted intents that intersect with the intent and would be revoked should the intent be mandated for support.

19. An apparatus, comprising:
an intent originator;
a memory element for storing data; and
a processor, wherein the processor executes instructions associated with the data, wherein the processor and the memory element cooperate, such that the apparatus is configured for:
sending an intent support request for an intent to a plurality of targets in a network;
receiving intent pre-commits from a portion of the plurality of targets and intent pre-aborts from a remaining portion of the plurality of targets, each intent pre-commit indicative of ability to support the intent, and each intent pre-abort indicative of inability to support the intent;
determining whether the intent is to be added to the domain in view of potentially impacted intents; and
instructing the plurality of targets to commit to the intent if the intent is to be added to the domain.

20. The apparatus of claim 19, wherein the operations further comprise converting the intent support request to a configlet.
